(19) United States
(12) Patent Application Publication
(10) Pub. No.: US 2007/0121286 A1
(43) Pub. Date: May 31, 2007

(54) MEMORY MODULE AIRFLOW REDIRECTOR

(75) Inventors: Jimmy Grant Foster Sr., Morrisville, NC (US); Michael Sean June, Raleigh, NC (US); Albert Vincent Makley, Raleigh, NC (US); Jason Aaron Matteson, Raleigh, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/164,576

(22) Filed: Nov. 29, 2005

(51) Int. Cl. G06F 1/20

(52) U.S. Cl. 361/687

(57) ABSTRACT

A method, apparatus and system are disclosed for utilizing a mechanical air redirection device with air cooled computer assemblies in order to evenly distribute airflow to provide balanced cooling of heat producing components, such as memory chips and boards. The present invention improves the thermal distribution and dissipation of heat for computer and memory systems when some memory devices are removed or left uninstalled.

### TECHNICAL FIELD

This invention relates to memory devices within computer systems and to the thermal performance of such devices and systems. More particularly, this invention relates to the field of air cooled computer systems and to a mechanical air redirection device for distributing airflow through a computer assembly having heat producing components, such as memory boards.

### BACKGROUND

Providing adequate cooling to computer assemblies is becoming increasingly difficult as high powered heat producing components such as microprocessors, memory, and application specific integrated circuits (ASICs) create higher thermal cooling demands. The cooling effectiveness is limited by the size, cost and noise of higher output cooling fans.

Typically, existing airflow capacity has not adequately cooled all of the heat producing components due to fan size, cost or noise constraints, forcing either larger, more expensive or noisier fans or orienting the heat producing components in a less desirable layout in order to meet the cooling requirements of the system. Often, heat producing components such as microprocessors, storage devices, expansion cards, power supplies, ASIC's and memory boards are oriented parallel to or along the airflow to improve cooling characteristics. However, in some situations, providing other orientations for these components would be preferred. In addition, heat producing components may also be located both above and below the printed circuit board (PCB), creating a need to provide adequate cooling to these components in either instance.

Additionally, computer memory systems are increasing in information storage capacity and density and also in data processing speed, while computer enclosure sizes continue to decrease while still housing essentially the same number of components, all contributing to an increasing challenge in providing adequate thermal cooling for heat-generating computer components. Previously a system with multiple dynamic random access memory (DRAM) or dual in-line memory module (DIMM) devices did not require much (if any) direct cooling beyond normal air circulation and convection, but recent designs have not been adequate in their ability to sufficiently cool the memory system and other heat-generating computer components.

Current solutions to this problem include increasing the airflow with more fans or more expensive fans, limiting performance or limiting the number of components (including memory devices) in the system. Current integrated circuit (IC) designs attempt to distribute this heat load among installed devices (including memory) in a way that allows all of them to operate at a lower temperature, but a thermal cooling problem occurs when some of the memory components allocated for use in the system are not installed. In fact, this problem gets worse as the number of installed memory components decreases, even though there is less total heat generated by the system.

A cooling system is needed that can evenly distribute airflow in order to provide balanced cooling of heat producing components, such as dynamic random access memory (DRAM) or dual in-line memory module (DIMM) chips and memory boards. A solution to the cooling problem is also needed that allows some memory devices to be removed (or left uninstalled) if desired, and that allows heat producing components to be located both above and below the printed circuit board (PCB), and also to be oriented in any direction with respect to the airflow, all while still meeting system noise, size and cost constraints.

### SUMMARY OF THE INVENTION

The present invention provides a method, apparatus and system utilizing a mechanical air redirection device for air cooled computer assemblies that can evenly distribute airflow in order to provide balanced cooling of heat producing components, such as memory chips and boards. The present invention improves the thermal distribution and dissipation of heat for computer and memory systems when some memory devices are removed or left uninstalled. In so doing, the present invention also allows heat producing components (such as DRAM/DIMM memory, ASICs and microprocessors) to be located both above and below the printed circuit board (PCB) and to be oriented in any direction with respect to the airflow, while still providing adequate cooling at any desired airflow rate, orientation and noise level, while still meeting system size, noise and cost constraints.

Specifically, this invention solves the above-described problems by providing mechanical airflow redirector(s) that can be optimized to a specific size, type, configuration or orientation for different sizes, types and numbers of allocated memory locations (or “sockets”) in a computer system, and for different sizes, orientations, types, and numbers of memory components installed (or “populated”) in those locations, including dynamic random access memory (DRAM) or dual in-line memory module (DIMM) chips and memory boards. The airflow redirectors of the present invention are designed to create an effect on airflow similar to that caused by memory modules that would otherwise be installed in vacant memory locations. This effect minimizes the loss of airflow that would ordinarily have occurred in the vacant locations, and as a result significantly increases airflow around the installed memory modules. A significant improvement in thermal cooling is thus realized compared to existing methods, even though there is no more total airflow to dissipate the heat load than in a fully populated memory system.

It is therefore an object of the present invention to overcome the disadvantages of the prior art by providing a method, apparatus and system using a mechanical air redirection device for air cooled computer assemblies to evenly distribute airflow so as to provide balanced cooling of heat producing components.

It is another object of the present invention to overcome the disadvantages of the prior art by providing a method, apparatus and system using a mechanical air redirection device to improve thermal distribution and dissipation of heat for computer memory systems when some memory device(s) are removed or left uninstalled.

It is another object of the present invention to overcome the disadvantages of the prior art by providing mechanical airflow redirector(s) to minimize the loss of airflow in vacant memory locations and to increase airflow around installed memory modules.

It is another object of the present invention to overcome the disadvantages of the prior art by providing mechanical airflow redirector(s) to create an effect on airflow in vacant memory locations similar to the effect created by installed memory module(s).

It is another object of the present invention to overcome the disadvantages of the prior art by providing mechanical airflow redirector(s) optimized in size, type, configuration or orientation for each size, type or number of allocated memory module locations and for each size, orientation or type of memory component installed in a computer system.

It is another object of the present invention to overcome the disadvantages of the prior art by providing mechanical airflow redirector(s) that cause a significant improvement in thermal cooling without increasing total airflow to dissipate at least the same heat load as experienced in a fully populated memory system.

It is another object of the present invention to overcome the disadvantages of the prior art by providing mechanical airflow redirector(s) that allow heat producing components to be located above and below the printed circuit board and to be oriented in any direction with respect to the airflow.

It is another object of the present invention to overcome the disadvantages of the prior art by providing mechanical airflow redirector(s) that allow adequate cooling in a computer assembly at any desired airflow rate, orientation and noise level, while still meeting system size, noise and cost constraints.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DRAWINGS

FIG. 1 is a perspective view of a prior art embodiment of an air cooled computer assembly with a system for directing the airflow.

FIG. 2 is a bottom perspective view of a prior art embodiment of an air cooled computer assembly with a system for directing the airflow showing a portion of the bottom side of the printed circuit board (PCB) assembly.

FIGS. 3A-3D show an eight (8) socket memory board populated with eight (8), six (6), four (4) and two (2) installed memory modules, respectively.

FIGS. 4A-4C show a six (6) socket memory board populated with six (6), four (4) and two (2) installed memory modules, respectively. FIG. 4D shows a four (4) socket memory board populated with two (2) installed memory modules.

FIGS. 5A & 5B show an eight (8) socket memory board populated with six (6) and four (4) installed memory modules, respectively, using one embodiment of an airflow redirector of the present invention.

FIG. 6 shows an eight (8) socket memory board populated with two (2) installed memory modules and using another embodiment of an airflow redirector of the present invention.

FIGS. 7A & 7B show a six (6) socket memory board populated with four (4) and two (2) installed memory modules, respectively, using other embodiment(s) of an airflow redirector of the present invention.

### DETAILED DESCRIPTION OF THE PREFERRED EMBODIMENTS

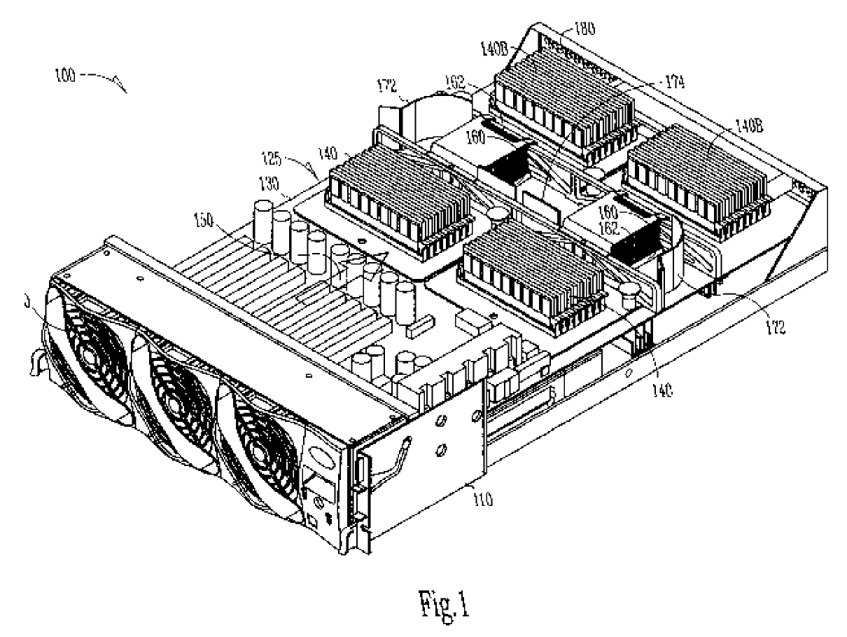

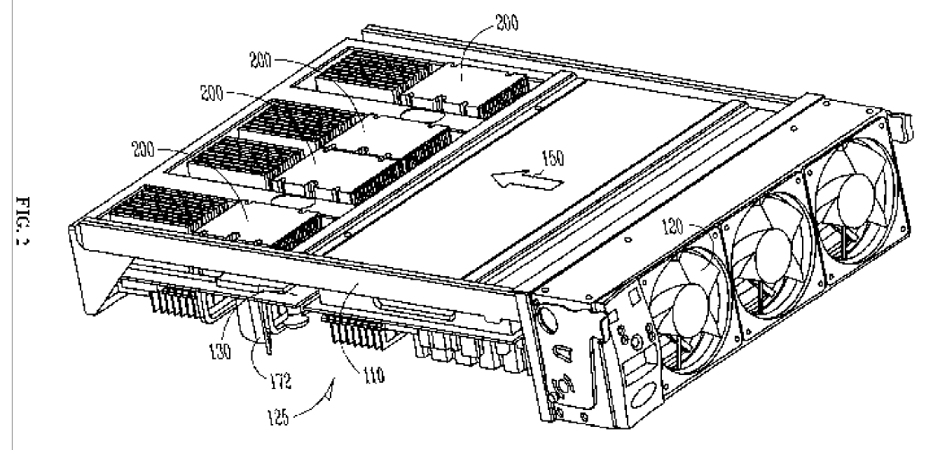

FIG. 1 shows a perspective view of a prior art embodiment of an air cooled computer assembly 100 including a tray structure 110. Optionally, the computer assembly fits into an enclosure that is “U” shaped. The computer assembly 100 also optionally includes at least one fan 120 positioned at an end of the tray structure 110 for providing airflow through the enclosure. The computer assembly 100 also includes a printed circuit board (PCB) assembly 125 positioned on the tray structure 110. PCB assembly 125 can include heat producing components optionally located on both the top and bottom sides of a printed circuit board 130.

In the example of FIG. 1, the top side of PCB assembly 125 includes memory boards (or “cards”) 140 that can consist of dynamic random access memory (DRAM) or dual in-line memory module (DIMM) chips. In this example, the memory boards 140 are positioned perpendicular to the direction of airflow 150. Also included in the example of FIG. 1 are application specific integrated circuits (ASICs) 160 with heat sinks 162 attached to the top of each. FIG. 2 shows a view of the computer assembly 100 that includes heat producing components, such as microprocessor(s) 200, located on the bottom side of the printed circuit board 130.

The heat producing components shown in FIGS. 1 & 2 can be positioned in any orientation (including along, across, parallel or perpendicular) with respect to the direction of airflow. The computer assembly 100 can also optionally include an air baffling system positioned proximate to the PCB assembly 125 to direct the airflow between the heat producing components. In the example of FIG. 1, the baffle system includes a pair of curved baffles 172 and a flat baffle 174 to direct the flow of air 150 around and between the heat producing components. In this example, the back 180 of the enclosure is perforated to allow the airflow 150 to exit the tray assembly 110. Optionally, the back of the tray assembly can be only partially perforated in certain areas to further balance airflow between the top and bottom or to fine tune the airflow after assembly.

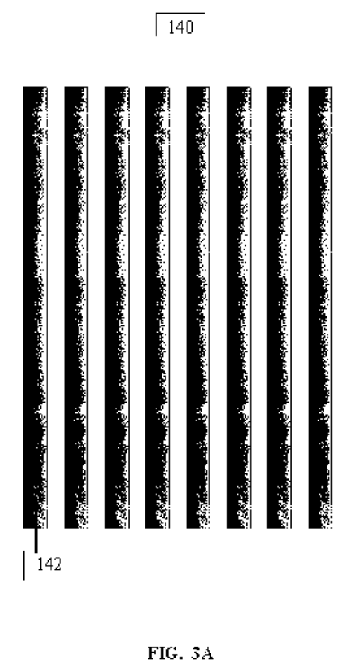

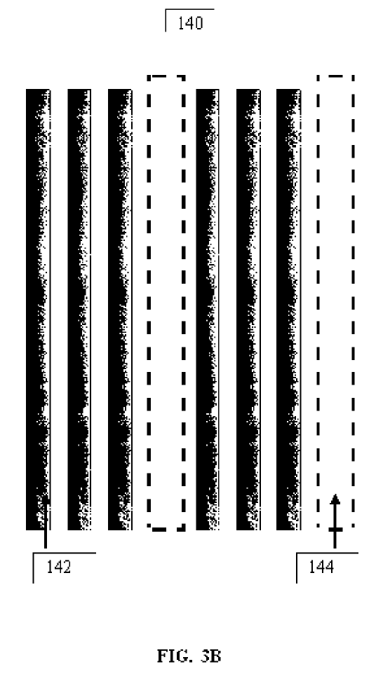

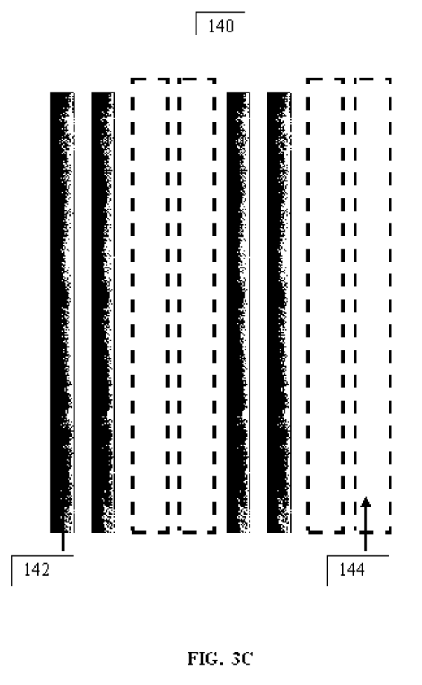

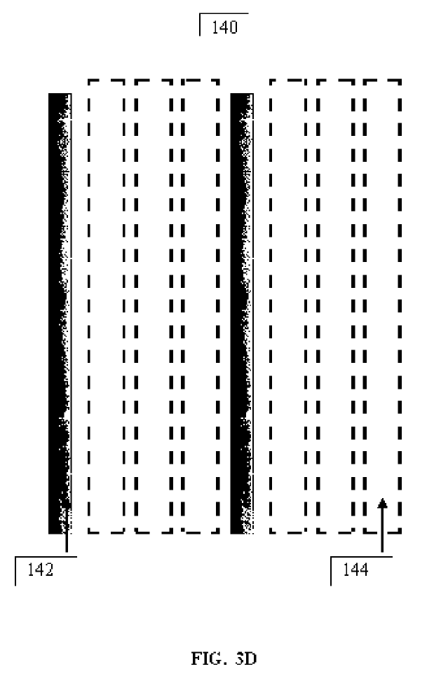

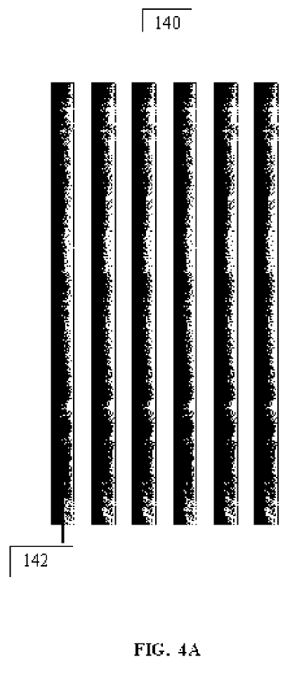

FIGS. 3A-3D show how memory modules 142 are typically organized in a computer system printed circuit board (PCB) assembly 125 (or “motherboard”) using a memory card 140 having eight (8) total allocated memory module locations (or “sockets”) 144. Specifically, FIGS. 3A-3D respectively show an eight (8) socket memory board 140 “populated” with eight (8), six (6), four (4) and two (2) installed memory modules 142 (shown as darkly shaded objects); which corresponds with no (0) memory modules removed, two (2) memory modules removed, four (4) memory modules removed, and six (6) memory modules removed from the eight (8) allocated sockets, respectively (shown as blank objects with a dashed outline to indicate the locations of empty sockets 144).

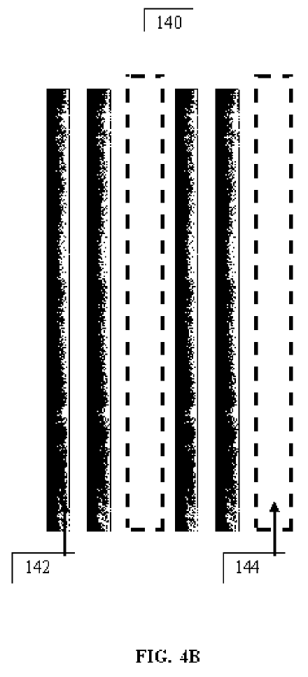

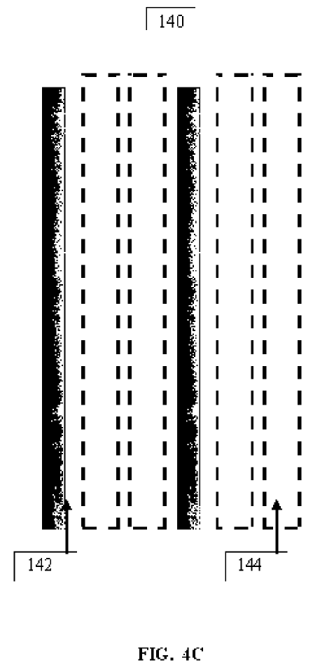

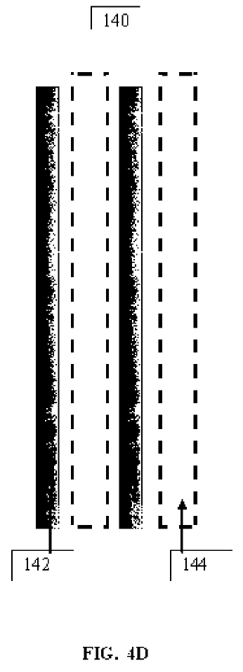

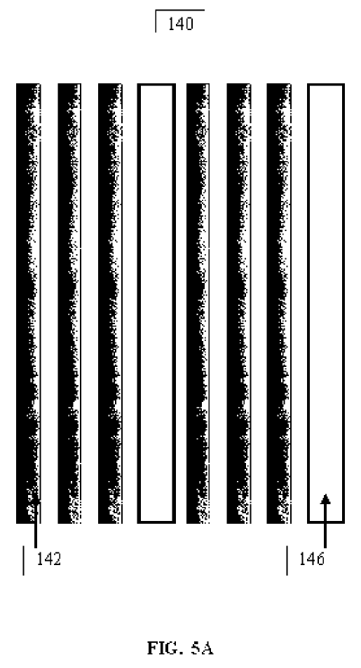

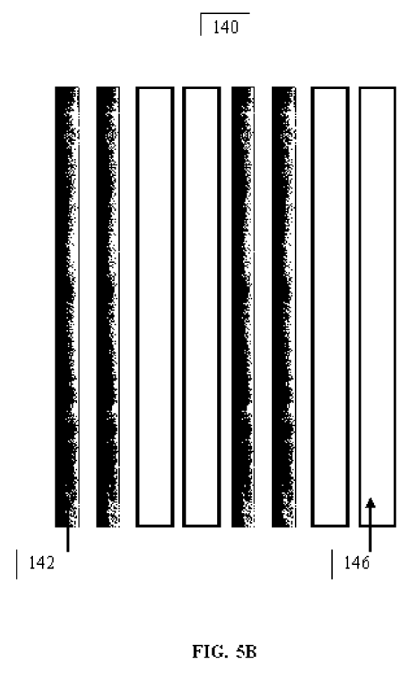

FIGS. 4A-4C are similar to FIGS. 3A-3D except that memory card 140 only supports six (6) total allocated memory module sockets 144, while FIG. 4D only supports four (4) total allocated memory module sockets. FIGS. 4A-4C show a six (6) socket memory board 140 populated with six (6), four (4) and two (2) installed memory modules 142, respectively. FIG. 4D shows a four (4) socket memory board populated with two (2) installed memory modules.

The diagrams in FIGS. 3 & 4 also show the memory module locations 144 populated (or depopulated) in adjacent sockets (or “channels”) which is typical with new computers, with half of the total memory capacity carried by memory modules 142 (or groups of memory modules) that are each separately located or installed in a different channel. This arrangement is typical of systems with synchronous (SDR) or double data rate (DDR and DDR II) DRAM/DIMM memory. In each case, more thermal stress is placed on the remaining memory modules as more memory modules are removed or left uninstalled, due to the combined effect of an increase in data processing activity (generating more heat) and a decrease in cooling capacity for each, resulting in the removal of less generated heat.

FIGS. 5A & 5B show an eight (8) socket memory board 140 populated with six (6) and four (4) installed memory modules 142, respectively, each using an airflow redirector 146 installed in the empty sockets 144 (shown as blank objects with a solid outline to indicate the presence of airflow redirectors 146 in memory socket locations 144). In existing systems, these sockets are usually left empty, and the resulting voids cause less airflow than normal to cross the sockets populated with memory modules, even though the heat load has increased slightly for each module due to an increase in processing activity. Instead of leaving the empty socket(s) vacant, the airflow redirector(s) 146 of the present invention are configured to seat into the one (1) or two (2) socket void(s) (as shown in FIGS. 5A & 5B respectively) in order to redistribute airflow 150 around the void so as to guide it across and through the channels containing the installed memory modules 142.

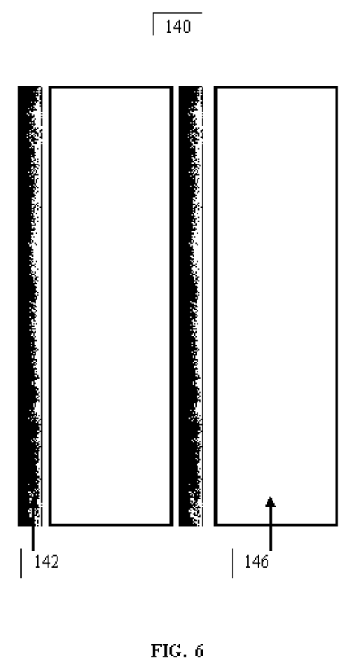

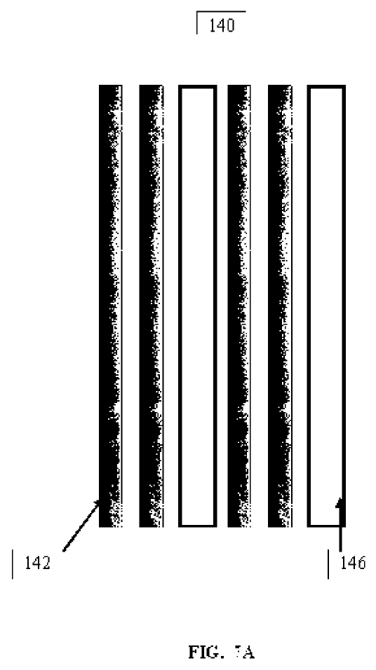

FIG. 6 shows an eight (8) socket memory board 140 populated with two (2) installed memory modules 142, and using another type of airflow redirector 146 configured to cover the vacant sockets 144. It is critical for this worst case scenario that the airflow 150 is properly maintained for the two (2) installed memory modules 142, because the combined negative effect of increased processing activity and decreased thermal cooling capacity is at its greatest in this instance. The configuration of the airflow redirector 146 shown in FIG. 6 is different than that shown previously, and has been optimized for this special case in order to minimize the loss of airflow 150 occurring within the two (2) vacant channels, each with three (3) adjacent vacant memory module sockets 144 collectively occupied by a single airflow redirector 146. Specifically, the airflow redirector design of FIG. 6 prevents airflow from passing between the installed memory modules 142, while at the same time increasing airflow around those installed memory modules by forcing more air around them. This is accomplished by providing a continuous surface for airflow redirector 146 that occupies at least as much (or more) of the total empty space between installed memory modules 142 than more than one individual airflow redirector of the type shown in FIG. 5 (or other individual memory modules) would collectively occupy if installed instead.

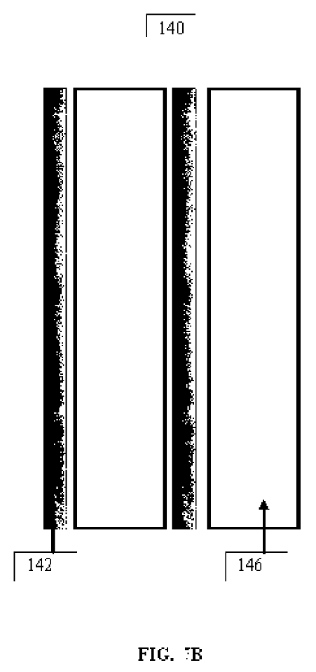

FIGS. 7A & 7B show a six (6) socket memory board 140 populated with four (4) and two (2) installed memory modules 142, respectively, and using other types of airflow redirectors 146 that are optimized for systems with six (6) total allocated memory module sockets 144 and configured to seat into the one (1) or two (2) socket void(s) respectively shown therein. The characteristics of the airflow redirectors shown in FIGS. 7A & 7B are similar to those described with respect to the airflow redirectors of FIGS. 5 & 6, respectively.

The airflow redirectors shown in FIGS. 5-7 can be configured to seat into any standard memory module socket by any conventional mechanical means, and can be made to work in either a “left to right” or a “right to left” memory socket orientation. Different sets of these airflow redirectors can be provided for different sized memory sockets, and the airflow redirector designs can be custom made to accommodate special quantities, heights, shapes, and other configurations based upon particular memory hardware types. This invention likewise can support computer systems using memory cards with more than eight (8) allocated memory module sockets (which ordinarily involves use of multiple memory cards each having six (6) or eight (8) allocated sockets). In these cases, the total airflow available for heat dissipation is spread over many more sockets, making the thermal cooling challenges created by fewer populated memory locations even more severe.

The airflow redirectors of the present invention thus create an effect on airflow similar to that caused by memory modules that would otherwise be installed in the vacant channels. This effect minimizes the loss of airflow that would ordinarily have occurred in the vacant channels, and as a result significantly increases airflow around the installed memory modules. A significant improvement in thermal cooling is thus realized compared to existing methods, even though there is no more total airflow to dissipate at least the same (or an increased) heat load than in a fully populated memory system.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A mechanical air redirection device configured for installation in at least one vacant memory location to distribute airflow within a computer assembly so as to provide substantially balanced cooling of heat producing components within the assembly.

2. A mechanical air redirection device of claim 1 configured to improve thermal distribution and dissipation of heat for a computer memory system when one or more memory devices are removed or left uninstalled.

3. A mechanical air redirection device of claim 2 configured to minimize the loss of airflow in at least one of the vacant memory locations and to increase airflow around memory devices installed in one or more of the other memory locations.

4. A mechanical air redirection device of claim 3 configured to distribute airflow substantially evenly so as create an effect in one or more vacant memory locations similar to the effect on airflow created by at least one installed memory device.

5. A mechanical air redirection device of claim 4 optimized in size, type, configuration or orientation for at least one size, type or number of allocated memory module locations and for one or more size, orientation, type or number of installed memory component.

6. A mechanical air redirection device of claim 5 configured to substantially prevent airflow from passing between installed memory devices by providing a continuous surface occupying at least as large a portion of the total empty space between memory devices as that occupied by individual memory devices installed in each vacant location.

7. A mechanical air redirection device of claim 6 configured for installation in at least one vacant location of a module having eight allocated memory locations.

8. A mechanical air redirection device of claim 7 configured for installation in one of two, four or six vacant memory locations.

9. A mechanical air redirection device of claim 7 configured for installation in a group of two or three vacant memory locations.

10. A mechanical air redirection device of claim 6 configured for installation in at least one vacant location of a module having six allocated memory locations.

11. A mechanical air redirection device of claim 10 configured for installation in one of two or four vacant memory locations.

12. A mechanical air redirection device of claim 10 configured for installation in a group of two vacant memory locations.

13. A mechanical air redirection device of claim 6 configured for installation in one of two vacant locations of a module having four allocated memory locations.

14. A mechanical air redirection device of claim 9 configured to substantially prevent airflow from passing between installed memory devices by providing a continuous surface occupying a larger portion of the total empty space between memory devices than that occupied by individual memory devices installed in each vacant location.

15. A mechanical air redirection device of claim 12 configured to substantially prevent airflow from passing between installed memory devices by providing a continuous surface occupying a larger portion of the total empty space between memory devices than that occupied by individual memory devices installed in each vacant location.

16. A computer system using one or more mechanical air redirection devices each configured for installation in at least one vacant memory location to distribute airflow within a computer assembly so as to provide substantially balanced cooling of heat producing components within the assembly.

17. The computer system of claim 16 wherein each mechanical air redirection device is configured to improve thermal distribution and dissipation of heat for a computer memory system when one or more memory devices are removed or left uninstalled.

18. The computer system of claim 17 wherein each mechanical air redirection device is configured to improve thermal cooling within a computer assembly without an increase in total airflow by dissipating at least the same heat load as experienced in a system having all memory devices installed.

19. The computer system of claim 16 wherein each mechanical air redirection device is configured for installation in a computer assembly having heat producing components located above and below a printed circuit board and oriented in any direction with respect to airflow.

20. A method of using one or more mechanical air redirection devices comprising the step of configuring each device for installation in at least one vacant memory location of a computer system to distribute airflow so as to provide substantially balanced cooling of heat producing components within the system at any airflow rate, orientation and noise level.
